(19) United States
(12) Patent Application Publication
(10) Pub. No.: US 2019/0161323 A1
(43) Pub. Date: May 30, 2019

(54) ELEVATOR DOOR LEAF AND MANUFACTURING PROCEDURE

(71) Applicant: Juan Ramon GOMIS RABASSA, Piantini-Santo Domingo (DO)

(72) Inventor: Juan Ramon GOMIS RABASSA, Piantini-Santo Domingo (DO)

(21) Appl. No.: 16/320,721

(22) PCT Filed: Jul. 14, 2017
(86) PCT No.: PCT/ES2017/070515

§ 371 Date: Jan. 25, 2019

(30) Foreign Application Priority Data
Jul. 27, 2016 (ES) P201631023

(51) Int. Cl. B66B 13/30; E06B 3/82

(52) U.S. Cl. CPC B66B 13/303; E06B 2003/7023; E06B 3/827

(57) ABSTRACT

An elevator door leaf formed by a front panel and a rear panel separated from each other but fitted into each other at their longitudinal edges by hemming or seaming, determining a space between the front panel and rear panel that is occupied by an expandable and hardenable foam that is injected under pressure into said space, such that it facilitates the attachment between at least two of the paired longitudinal edges created by fitting the front and rear panels together.

### TECHNICAL SECTOR OF THE INVENTION

The present invention discloses an elevator door leaf that comprises a front panel and a rear panel. Each panel is defined by a transversal top edge, a transversal bottom edge, and two longitudinal edges. The front panel and rear panel are separated from each other, but fitted into each other along their longitudinal edges. The invention also discloses a procedure for the manufacture of the door leaf.

### BACKGROUND OF THE INVENTION

Elevator doors are generally made up of one or more door panels, which are in turn formed by joining panels or sheets. The door panels need to fulfill a large number of safety requirements established specifically for elevators and their doors, applying to, for example, thermal insulation, fire resistance, and stability. For example, the thermal transmission through an elevator door must be minimal and the door panel or panels must be able to withstand large mechanical stresses, either because they may be subject to impacts and kicking, in situations in which a user trapped inside the elevator becomes agitated.

Patent CH365519 describes a door leaf that comprises various reinforcing sheets that are folded and welded on the lateral edges of the door sheets, which contain a mass of thermal insulation inserted between the door sheets in place.

Patent EP0838426 describes a door leaf formed by two panels, a front panel and a rear panel, welded to each other. The rear panel comprises one or more folds that create a space separating the front panel and rear panel, with the air between the panels providing a certain degree of thermal insulation. The welded joint between the two panels is spot welded, so the contact between the two panels, though minimal, provides a rigid connection that is stable over time. However, in case of fire, when the door leaf heats up, it may be deformed by the difference in thermal expansion caused by the temperature differences between the front and rear panels. The deformation of an elevator door in case of fire hinders the opening of the door that is blocked by the deformation, posing a safety risk. In addition, the maximum permitted widths of the void that are specified to prevent flames from penetrating could be exceeded.

Patent EP2455575 describes a door leaf made from folded sheets, specifically a box sheet and a cover sheet, in which a series of rear hooking means are formed on two parallel edge portions on the corresponding edges parallel to the box sheet and the cover sheet. The rear hooking means are hooked behind inside two door folds that are parallel to each other, and that at the same time can move in the longitudinal direction of the edge portions. A housing slot is formed in a third edge portion in one of the sheets, and a spring is formed in the other sheet that is inserted or fitted into the housing slot in the direction of movement. Before the box sheet and cover sheet are assembled using the rear hooking means and the movement of the sheets until the spring fits into the housing slot, an adhesive layer is applied to the box sheet between the four folded edge zones, an insulating insert is inserted on the adhesive layer, and an adhesive layer is applied on said insulating insert.

The door leaves folded as described above have the advantage that when the door is closed, the leaves are on a projection in the door frame. Since there is no visible separation space between the door and the frame, these doors generally provide greater thermal and acoustic insulation than door leaves with rounded enclosures, and they are especially suitable for use as fire-protection doors.

However, the placement of the insulating insert between the two door leaves requires a lot of floor space, because once the insulating insert has been placed on the adhesive on the box sheet, the cover sheet must be positioned in front of the box sheet and raised slightly so that the rear hooking means on the edges of the cover sheet properly fit into the rear hooking means of the box sheet, and thus allow the cover sheet to slide until the springs of the other upper and lower edges of one of the two sheets are inserted into the housing slots of the corresponding upper and lower edges of the other sheet. The large space required to carry out this procedure is clearly observed when attempting the mass production of this type of door.

The objective of the invention consists of providing an alternative door leaf that satisfies all of the stability requirements of an elevator door in regard to mechanical stresses, operational stability, thermal and acoustic insulation, and that serves as a fire door due to its fire resistance.

### EXPLANATION OF THE INVENTION

In order to provide a solution to the aforementioned drawbacks, the invention discloses an elevator door leaf formed by a front panel and rear panel separated from each other but fitted into each other along their longitudinal edges by hemming or seaming. In essence, the elevator door leaf that is the object of the invention is characterized in that it determines a space between the front panel and rear panel that is occupied by an expandable and hardenable foam that is injected under pressure into the space, such that it facilitates the attachment between at least two of the aforementioned paired longitudinal edges created by fitting the front and rear panels together. It should be noted that in the elevator door leaf that is the object of the invention, the panels that make it up are attached to each other only by the hemming or seaming of their longitudinal edges and by the foam filling injected under pressure, without requiring any screwed, riveted, or welded joints.

Hemming or seaming is done first by partially bending sections of the ends of the longitudinal edges of one of the panel back onto themselves, leaving sufficient space in the partial fold to allow the other panel to slide and a series of folded end sections of the ends of the longitudinal edges are inserted into the partially folded sections of the other panel. Once the folded end sections of the second panel have been fitted into the partial folds of the other panel, they are completely hemmed or seamed, folding all of the portions of the first panel so that they hold the folded end sections of the other panel. By means of injection, which applies pressure on the interior surfaces of the front panel and the rear panel, the sections of both panels, even if they have not been folded together from the start (because they have been slid and fitted together) are secured to each other, with the joint between the two panels secured when the foam expands.

Preferably, the expandable and hardenable foam will be polyurethane foam. Contrary to what would be expected, the door leaf that is the object of the invention, despite being filled will polyurethane foam injected under pressure, which is normally a relatively flammable material, has demonstrated good fire resistance, as a result of the combination of the hemming or seaming of the longitudinal edges in two stages (partial folding and later full folding) in combination with the securing of the hemming or seaming that the polyurethane injected under pressure produces when it expands, leaving virtually no hollow spaces inside the panel.

According to another characteristic of the elevator door leaf that is the object of the invention, the hemmed or seamed joints between the front and rear panels created by the overlapping of their respective longitudinal edges are formed by two sections of the ends of the longitudinal edges of the front panel folded back onto themselves, with a folded section of the respective end of the longitudinal edge of the rear panel inserted into the fold.

According to one embodiment of the invention, one of the hemmed or seamed joints between the front panel and the rear panel created by the overlapping of their longitudinal edges is directed in a direction parallel to that of the door leaf essentially aligned with the front face that makes up most of the front panel.

According to another characteristic of this embodiment, on the side of the hemmed or seamed joint that is aligned with the front face of the door leaf, the respective longitudinal edge of the rear panel is folded in an L-shape, with one of the arms of the L-shaped bend forming a first lateral side of the door leaf and the other arm the folded end section that is inserted into the section of the front panel that is folded back onto itself to form the hemmed or seamed joint.

According to another characteristic of this embodiment, the other hemmed or seamed joint between the front panel and the rear panel created by the overlapping of their longitudinal edges is directed in a direction perpendicular to that of the door leaf.

According to another characteristic of this embodiment, on the side of the hemmed or seamed joint that is directed in a direction perpendicular to that of the door leaf, the door leaf comprises a second lateral side made up by a folded part of the corresponding longitudinal edge of the front panel, finished at the end thereof with the section folded over onto itself that creates the hemmed or seamed joint, with an end section of the rear panel that forms a right angle with respect to the rear face of the sheet inserted into the fold of this section folded back onto itself, with the fold extending at a right angle in the opposite direction of the aforementioned side.

According to another characteristic of this embodiment of the invention, the folded part of the longitudinal edge of the front panel that makes up the second lateral side consists of a fold at a right angle of the part of the front panel that forms the front face, and the section folded back onto itself of the longitudinal edge is an extension in the same direction of this right-angle fold.

As an alternative to the aforementioned characteristic, the folded part of the longitudinal edge of the front panel that makes up the second lateral side consists of a first fold at a right angle of the part of the front panel that forms the front face, with the first right-angle fold extending a certain distance beyond the rear face, followed by an offset in the direction parallel to the plane of the rear face and of a second right-angle fold of which the section folded back onto itself of the longitudinal edge forms part.

According to another embodiment of the invention, in the elevator door leaf, the two hemmed or seamed joints between the front and rear panels created by the overlapping of their longitudinal edges, formed by respective sections of the ends of the longitudinal edges of the front panel folded back onto themselves, with a corresponding folded end section of the respective end of the longitudinal edge of the back panel inserted into the fold, they are directed in a direction parallel to the front face that makes up most of the front panel and to the rear face that makes up most of the rear panel.

According to another characteristic of the invention, and for any of the previous embodiments, the door leaf may comprise, in the space between the front panel and the rear panel, a C-shaped reinforcement profile, that extends side to side between two lateral edges of the door leaf and is arranged at one corresponding longitudinal end of the door leaf, in which the reinforcement profile is made up of a first flat face and flat second and third faces that are connected perpendicular to the first face, in which the first face is oriented according to a plane perpendicular to the front face of the panel that makes up most of the front panel, with the first face attached to the respective transversal edges of one longitudinal end of the front and rear faces of the lateral sides of the door leaf, and with the first face comprising an access opening connected to the inside space separating the front panel and rear panel, and wherein the second face and the third face of the reinforcement profile extend from the first face in a direction parallel to the front face and the rear face of the door leaf, respectively.

Optionally, the door leaf may comprise a second C-shaped reinforcement profile at the other longitudinal end of the door leaf, with the second reinforcement profile identical to the first reinforcement profile, or with the only difference being that the first surface of the second profile does not have the access opening.

As an alternative to the reinforcement profile or profiles described above, another embodiment of the door leaf may comprise, at one of its longitudinal ends, a reinforcement plate in the space between the front panel and the rear panel, arranged parallel and in contact with the inside face of the rear panel with the other side forming the rear face of the leaf, with the reinforcement plate extending from side to side between the two lateral edges of the door leaf, and the reinforcement plate being equipped with multiple openings that line up with a series of mounting openings made in the rear face of the panel that are suitable for installing elements for fastening the elevator door leaf to the elements of the mechanisms that produce the opening and closing movements of the door leaf.

Preferably, the front panel and rear panel will be made of galvanized or stainless steel sheet metal, with a thickness comprised between 0.5 and 2 mm. Also preferably, the thickness measured from the surface of the front face to the surface of the rear face of the leaf is comprised between 15 and 60 mm; and the length of the door leaf, measured from the top transversal edge to the bottom transversal edge of the front panel is comprised between 1000 and 6000 mm. Also preferably, the distance between the surfaces of the two lateral edges of the door leaf is comprised between 150 and 1000 mm.

In addition to being made of galvanized or stainless steel sheet metal, the front panel and rear panel may be made of stripped sheet metal, pre-painted sheet metal, and plastic-coated sheet metal.

According to another characteristic of the invention, the filling of polyurethane foam injected under pressure that occupies the space between the front panel and the rear panel is an expanded, cured injected polyurethane based on a mixture of at least one polyol with an isocyanate component under reaction conditions. Advantageously, the mixture of at least one polyol component with an isocyanate component further comprises a blowing agent.

According to another aspect of the invention, a procedure is disclosed for the manufacture of an elevator door leaf like the one in the invention described above. The procedure comprises the stage of forming a housing with a front panel and a rear panel, fitting the longitudinal edges of the front panel with the longitudinal edges of the rear panel with hemming or seaming, forming a space between the front panel and the rear panel. The procedure is characterized in that later, an expandable and hardenable foam is injected under pressure into the space between the two panels and is confined under pressure against the front panel and rear panel when it hardens, completely filling the space between the panels.

Preferably, the expandable and hardenable foam is an injected polyurethane foam based on a mixture of at least one polyol component and one isocyanate component under reaction conditions.

According to another characteristic of the procedure, the pressure at which the expandable and hardenable foam is injected is preferably between 0.37 and 0.82 Kg/cm², and it is injected at a temperature between 27 and 54° C.

### BRIEF DESCRIPTION OF THE DRAWINGS

The attached drawings illustrate by way of non-limiting example, several embodiments of the elevator door leaf that is the object of the invention. In said drawings:

FIG. 1 is a bottom view of an embodiment of the door leaf of the invention;

FIG. 2 is a bottom view of another embodiment of the door leaf of the invention that comprises a reinforcement profile between the front panel and the rear panel;

FIG. 3 is a magnified view of the hemmed or seamed joint on the left side of the longitudinal edges of the panels that make up the door leaf in FIG. 1;

FIG. 4 is a magnified view of the hemmed or seamed joint of the right side of the longitudinal edges of the panels that make up the door leaf in FIG. 1;

FIG. 5 is a magnified view of another alternative for the hemmed or seamed joint of the left side of the longitudinal edges of the panels that form the door leaf in FIG. 1

FIG. 6 is a perspective view of the top part of the door leaf in FIG. 1 seen from the front face;

FIG. 7 is a perspective view of the top part of the door leaf in FIG. 1 seen from the rear face;

FIG. 8 is a perspective view of the top part of the door leaf in FIG. 2 seen from the rear face;

FIGS. 9, 10, and 11 are respective rear, front, and side views of the door leaf in FIG. 1;

FIG. 12 is an exploded perspective view of a longitudinal end of another embodiment of the door leaf that is the object of the invention, which comprises a reinforcement plate inside thereof, adjacent to the rear panel; and

FIG. 13 is a diagram of the two stages used to obtain a door leaf with its longitudinal edges hemmed or seamed prior to the injection of polyurethane foam under pressure into the space between the front panel and rear panel to form a door leaf that is the object of the invention.

### DETAILED DESCRIPTION OF THE DRAWINGS

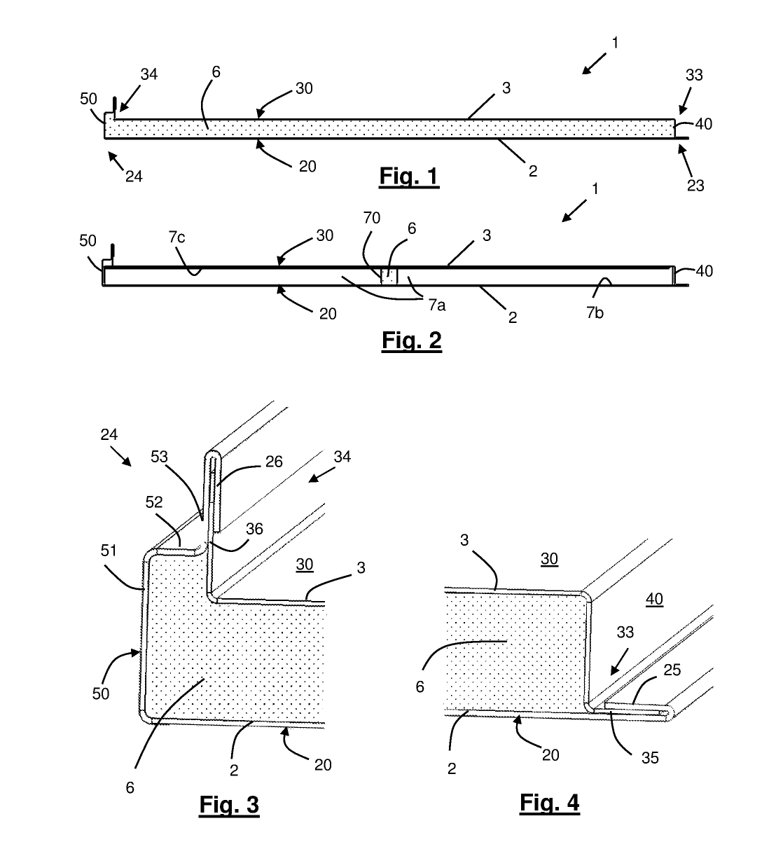

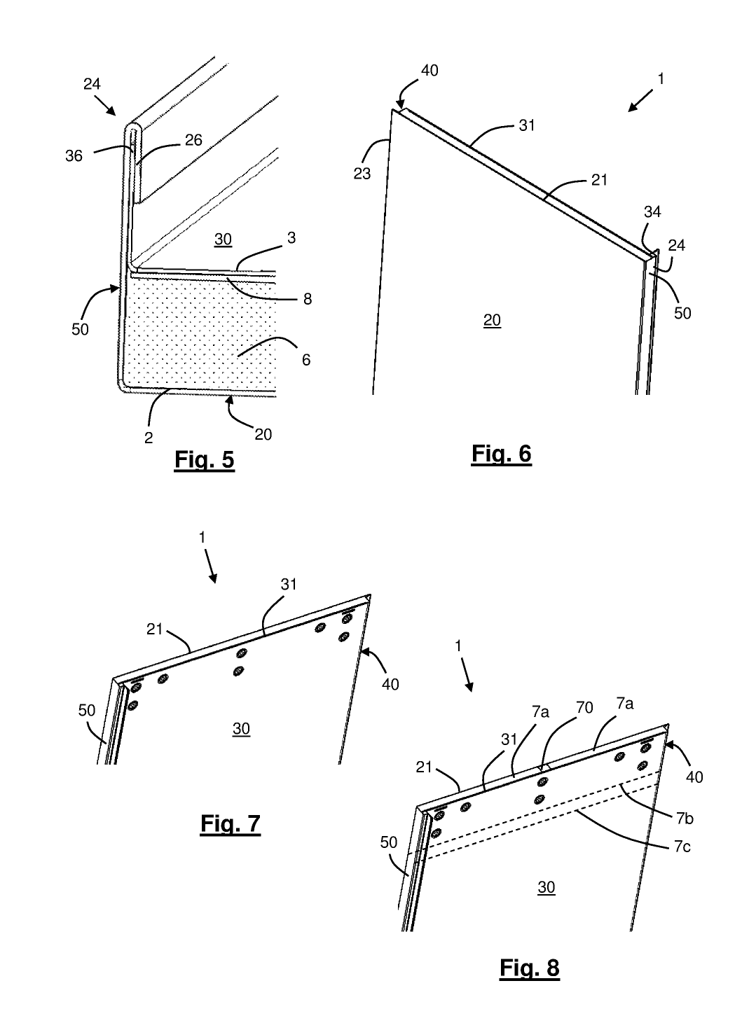

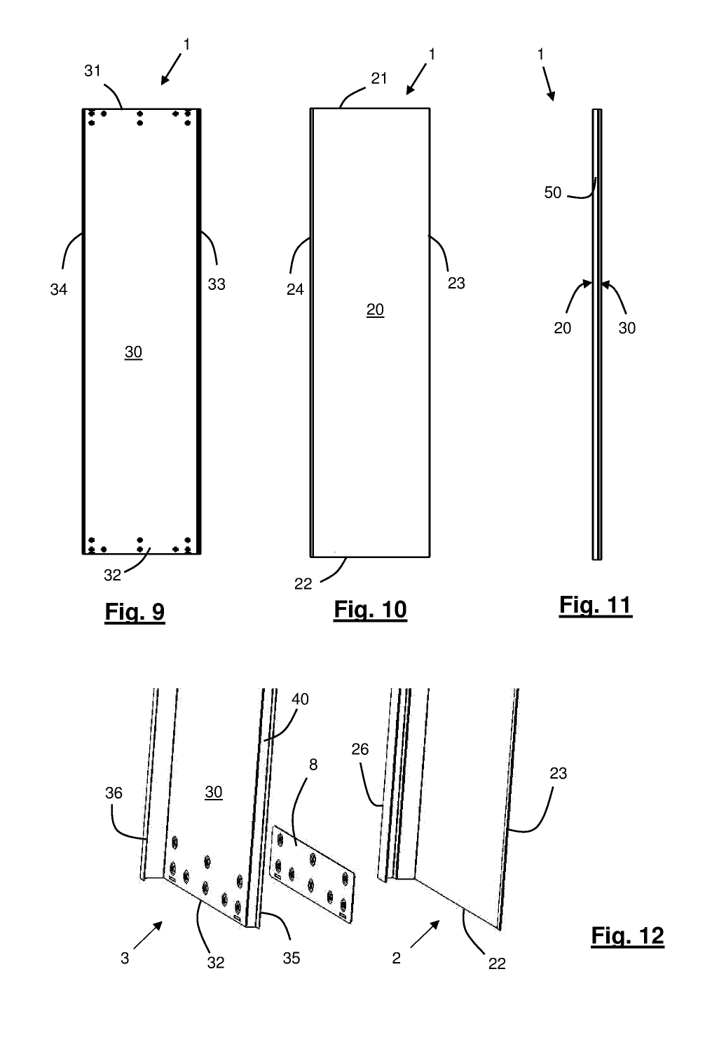

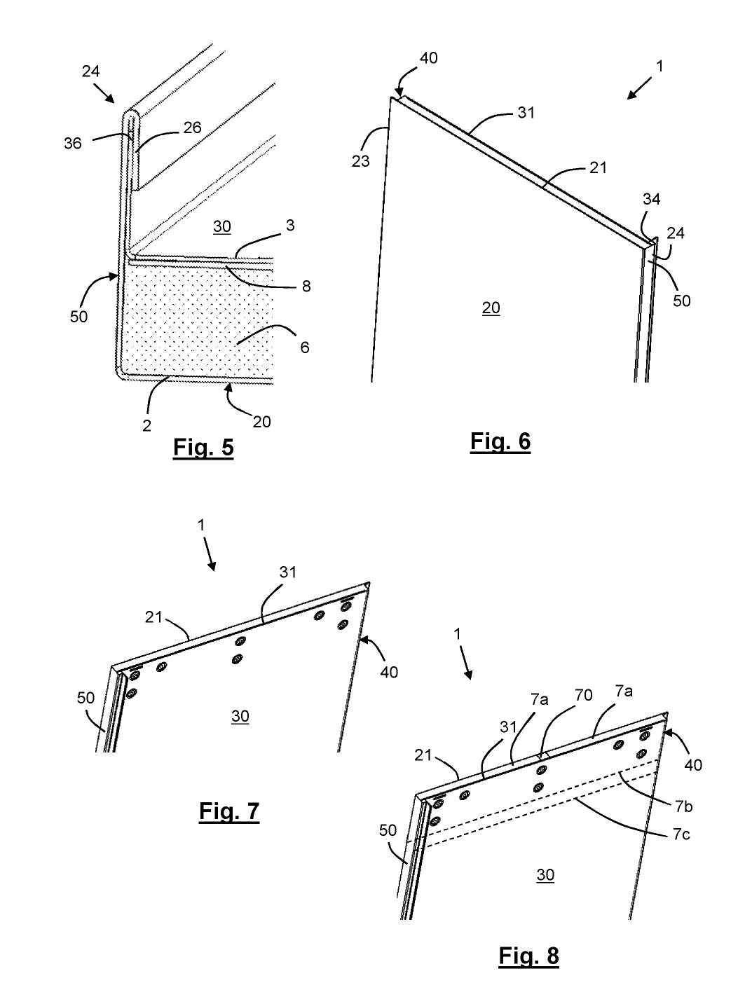

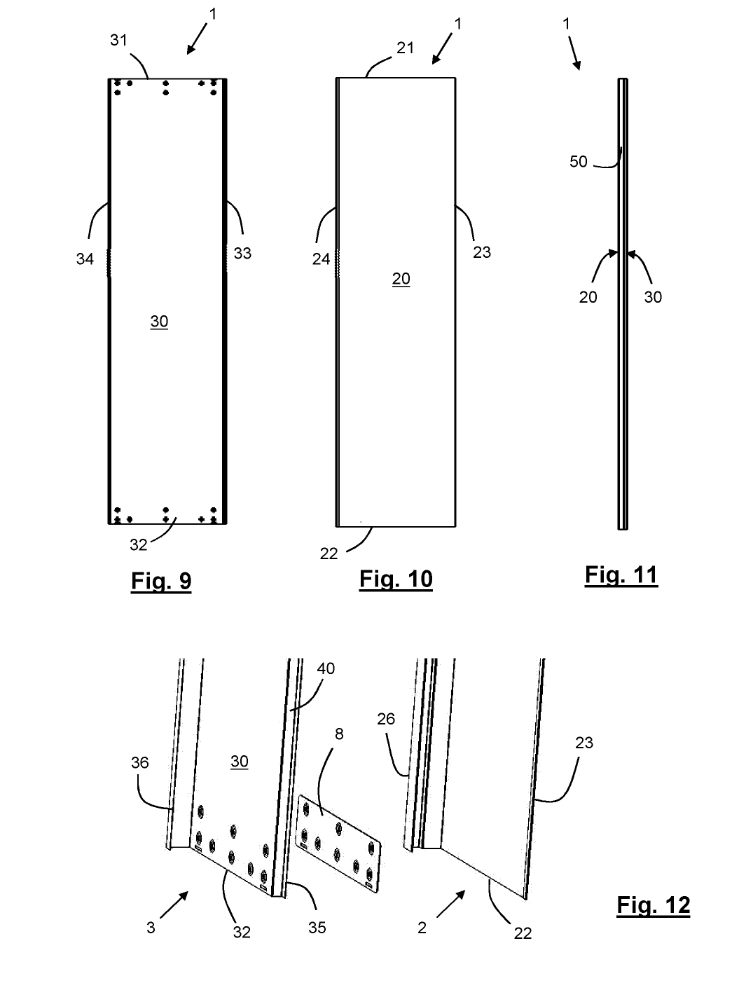

FIGS. 9 to 11 represent three elevation views of a first embodiment of an elevator door leaf 1. In addition, FIGS. 6 and 7 show views of the top part of said door leaf 1 and FIG. 1 shows a bottom view thereof. As shown, the door leaf 1 is formed by a front panel 2 and rear panel 3 separated from each other but fitted into each other along their longitudinal edges 23-33 and 24-34 by hemming or seaming.

The front panel 2, as shown in FIG. 10, is mostly formed by a flat front face 20, limited in the longitudinal direction by the top transversal edge 21 and by the bottom transversal edge 22, and limited in the transversal direction by a right longitudinal edge 23 and by a left longitudinal edge 24. It should be noted that the adjectives top, bottom, right, and left should not be understood as limiting, because the front panel 2 and also the rear panel 3 can be rotated depending on the requirements of the elevator door and the left edge will then be positioned on the right side and the top on the bottom. These adjectives are used in this description to provide clarity to facilitate the understanding of the explanations of the figures. As for the rear panel 3 shown in FIG. 9, it also includes a top transversal edge 31, a bottom transversal edge 32, a right longitudinal edge 33, and left longitudinal edge 34, with a flat rear face 30 forming most of the rear panel 3. In addition to a front face 20 and a rear face 30, the door leaf 1 also comprises a right lateral face 40 and a left lateral face 50 made up of the joints between the two panels 2 and 3, as explained below.

The hemmed or seamed joints between the front panel 2 and rear panel 3 created by the overlapping of their respective longitudinal edges 23-33 and 24-34 are formed by two sections of the ends of the longitudinal edges 23 and 24 of the front panel 2 bent back onto themselves 25 and 26, with a folded end section 35, 36 of the respective end of the longitudinal edge 33, 34 of the rear panel 3 inserted into the fold.

FIG. 4 shows one preferred option for the hemmed or seamed joint between the front panel 2 and the rear panel 3 created by the overlapping of their respective right longitudinal edges 23 and 33 in which this joint is directed in a direction parallel to that of the door leaf 1 essentially aligned with the front face 20 that makes up most of the front panel 2. As shown, this joint is formed by the section bent back onto itself 25, with the folded end section 35 into which the end of the longitudinal side 33 is folded inserted into the fold. The right longitudinal edge 33 of the rear panel 3 is folded in an L shape. One of the arms of the L-shaped bend forms a first lateral edge 40 (right lateral edge) of the door leaf 1, while the other arm forms the folded end section 35 that is inserted between the section folded back onto itself 25 of the front panel 2, thus forming the hemmed or seamed joint of the right side of the door leaf 1.

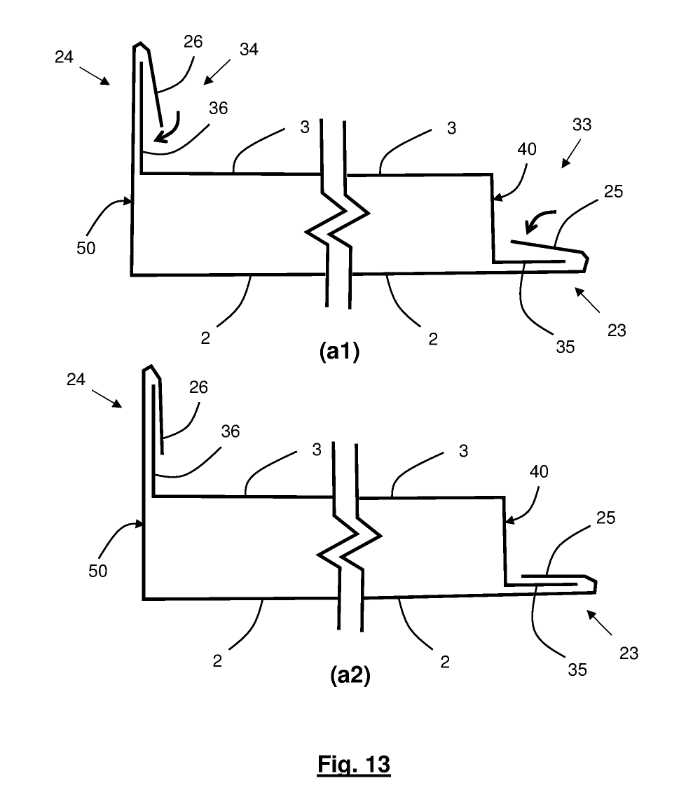

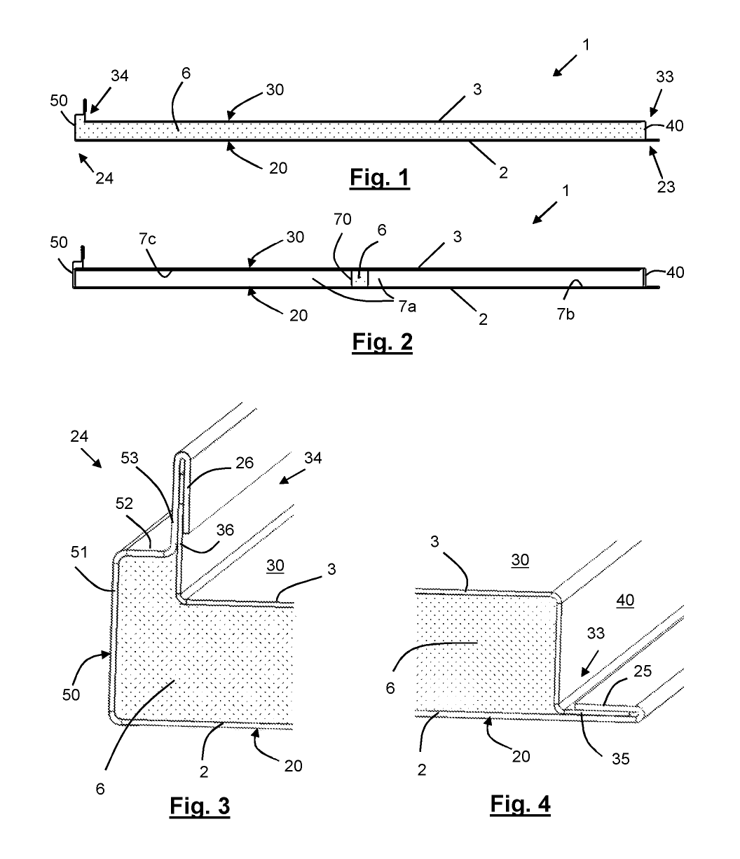

In regard to the hemmed or seamed joint of the other side of the door leaf 1 in FIG. 1, the left side, this is shown in detail in FIG. 3. As shown, in this case, the joint formed by the overlap of the left longitudinal edges 24 and 34 is directed in a direction perpendicular to that of the door leaf 1, because the section folded back onto itself 26 of the front panel 2, into which the end section 36 of the rear panel 3 is inserted, is oriented such that it forms practically a right angle with respect to the front face 20 or the rear face 30. The figure also shows that the second lateral side 50 of the door leaf 1, the left lateral edge, is formed by a folded part of the corresponding longitudinal edge 24 of the front panel 2 ending at the end thereof with the section folded back onto itself 26, creating the hemmed or seamed joint. An end section 36 of the rear panel 3, which forms a right angle with respect to the rear face 30 of the door leaf, is inserted into the fold of this section folded back onto itself 26, with the right-angle fold extending in the direction opposite the front face 20.

Continuing with the joint shown in FIG. 3, the folded part of the longitudinal edge 24 of the front panel (the part that forms the second lateral side 50) consists of a first right angle bend 51 of the part of the front panel 2 that forms the front face 20. The first fold 51 extends at a right angle with respect to the front face a certain distance beyond the rear face 30, and followed by an offset 52 in the direction parallel to the plane of the rear face 30 and by a second right-angle fold 53 of which the section bent back onto itself 26 of the longitudinal edge 24 forms part.

As an alternative to the hemmed or seamed joint of the left side of the door leaf 1 described and presented in FIG. 3, the longitudinal edges 24 and 34 may be joined using the structure shown in FIG. 5. In this case, the folded part of the longitudinal edge 24 of the front panel 2 that makes up the second lateral side 50 consists of a fold at a right angle of the part of the front panel 2 that forms the front face 20, and the section bent back onto itself 26 of the longitudinal edge 24 is an extension in the same direction of this right-angle fold.

Although in the two options with hemmed or seamed joints of the left side of the door leaf 1 by overlapping the left longitudinal edges 24-34 of panels 2 and 3 shown in FIGS. 3 and 5, the joint is directed perpendicular to the direction of the door leaf 1, in other words, directed in a direction perpendicular to the front face 20 and rear face 30, it is also possible for the door leaf 1 to have other joint configurations for the left side, for example, with the section folded back onto itself 26 of the end of the longitudinal edge 24 of the front panel 2 and the folded end section 36 of the left end of the longitudinal edge 34 of the rear panel 3 inserted into the section folded back onto itself 26 are oriented or directed in a direction parallel to the front face 20, above the rear face 30. One example of this configuration is the one with the front and rear panels 2 and 3 shown in FIG. 12.

In all of the door panels 1, regardless of the embodiment in question, it is important to note that the space between the front panel 2 and rear panel 3 is occupied by an expandable and hardenable foam 6, preferably polyurethane foam injected under pressure into the space, such that it facilitates the attachment between the paired right longitudinal edges 23 and 33 and the left longitudinal edges 24 and 34 created by fitting the front panel 2 and rear panel 3 together.

This filling of polyurethane foam injected under pressure that occupies the space between the front panel 2 and the rear panel 3 is an expanded, cured injected polyurethane based on a mixture of at least one polyol with an isocyanate component under reaction conditions. The aforementioned mixture may also comprise a blowing agent.

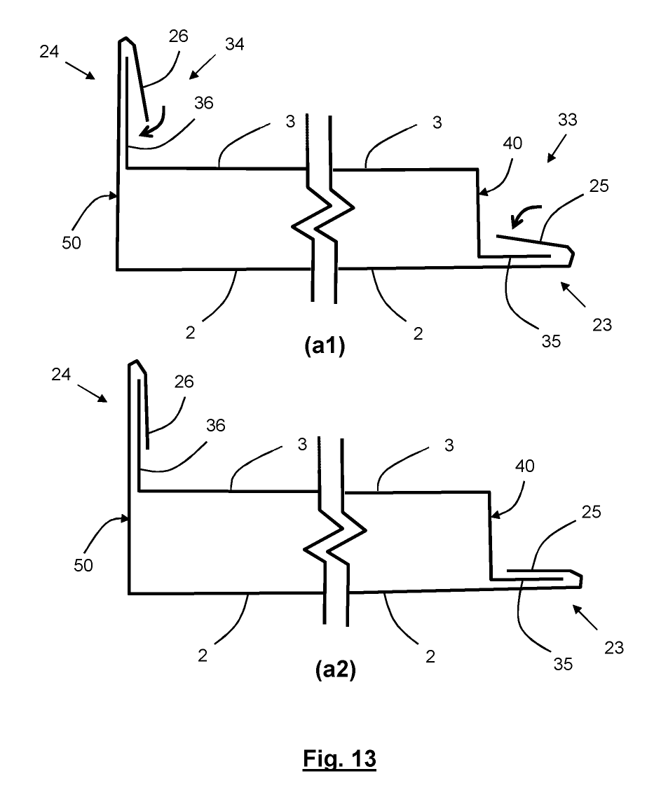

The injection of polyurethane foam, as mentioned, secures the hemmed or seamed joint of the longitudinal edges 23-33 and 24-34. It is important to note that before the filling of polyurethane foam is injected, the front panel 2 and the rear panel 3 have been assembled as follows, described schematically in the phases (a1) and (a2) in FIG. 13.

In the first phase (a1), both the front panel 2 and rear panel 3 have been shaped by a series of folds made in their respective lateral edges 23, 24, 33, 34. The geometry of the left lateral edges 24 and 34 corresponds to the geometry explained in FIG. 5, while the geometry of the right lateral edges 23 and 33 corresponds to the geometry explained in FIG. 4. In regard to FIGS. 5 and 4, note that in the phase (a1) of FIG. 13 the sections folded onto themselves 25 and 26 of the ends of the longitudinal edges 23 and 24 of the front panel 2 have been partially folded to form an acute angle, in other words, without completing a fold of the section back onto itself. This partial fold is to allow the respective folded end sections 35 and 36 of the ends of the longitudinal edges 33 and 34 of the rear panel 3 to slide freely to move into and fit into the partially folded space of the sections partially folded back onto themselves 25 and 26.

In the second phase (a2), pressure is applied on the sections partially folded back onto themselves 25 and 26 in the direction of the arrows drawn on in the phase (a1), so that these sections 25 and 26 end up completely folded back onto themselves, with the folded sections essentially parallel and in contact with the respective folded end sections 35 and 36 with which they overlap.

Starting with the door leaf formed by the front panel 2 and rear panel 3 with their respective longitudinal edges fitted into each other by hemming or seaming, obtained in phase (a2), the door leaf is prepared for the injection of the expandable and hardenable foam 6, specifically polyurethane foam that can be obtained from a mixture of its components.

The preparation consists of sealing all openings and/or spaces of the exterior surface of the assembly of the door leaf that is connected to the interior space that separates the front panel 2 and the rear panel 3, covering the top and bottom ends, leaving or providing only one access opening 70 to the interior space between the two bottom transversal edges 22 and 32, or between the two top transversal edges 21 and 31 of the panels 2 and 3, depending on the side through which the mixture is injected.

It is also important to remember to seal the openings that may have been made in the panels 2 and 3, for example, the opening to form the door handle and the mounting openings made in the longitudinal ends of the rear face 30 of the rear panel 3 for the installation of the means for fastening the elevator door leaf 1 to the elements of the mechanisms that generate the movement to open and close the door leaf 1. FIGS. 9 and 12 show these mounting openings. Specifically, the door leaf 1 shown in the close-up in FIG. 12 comprises, at one of its longitudinal ends, a reinforcement plate 8 in the space between the front panel 2 and the rear panel 3, arranged parallel and in contact with the inside of the rear panel 3, the other side of which forms the rear face 30 of the rear panel 3. This reinforcement plate 8 extends from side to side between the two lateral edges 40 and 50 of the door leaf 1 and it is also equipped with several openings that line up with the aforementioned mounting openings of the rear panel 3. The reinforcement plate 8 helps secure fastening means, for example nuts, firmly to the door leaf 1.

In place of the reinforcement plate 8, the door leaf 1 may comprise, also in the space between the front panel 2 and the rear panel 3, a C-shaped reinforcement profile, that extends from side to side between the two lateral edges 40, 50, arranged on one and on each one of the two longitudinal ends of the door leaf 1. This is the case of the door leaf 1 in FIG. 2 and in FIG. 8. In FIG. 8, the parts of the reinforcement profile are shown in dotted lines to indicate that they are inside the door leaf 1, between the rear face 30 and the front face 20. The reinforcement profile is formed by a first flat face 7a and second and third face 7b and 7c, which are also flat and connected perpendicular to the first face 7a to form a C-shaped profile.

The first face 7a of the reinforcement profile is oriented according to a plane perpendicular to the front face 20 that makes up most of the front panel 2. The first face 7a is connected to the respective transversal edges of one of the longitudinal ends of the door leaf, in other words, to the top transversal edges 21 and 31, or to the bottom transversal edges 22 and 32, and to the lateral edges 40 and 50 of the door leaf 1, such that the first face 7a is similar to a cover that closes off (at least to a large extent) one longitudinal end of the door leaf 1. In fact, as shown in FIGS. 1 and 8, the first face 7a is equipped with a small window or access opening 70 connected to the interior space separating the front panel 2 and the rear panel 3. The second face 7b and third face 7c of the reinforcement profile, which would be the wings of the reinforcement profile, extend from the first face 7a in a direction parallel to the front face 20 and the rear face 30 of the door leaf 1, respectively, as shown in FIG. 8. The face 7c may be equipped, like the reinforcement plate 8, with several openings that line up with the aforementioned mounting openings of the rear panel 3. In short, there are embodiments of door panels 1 that will not have any reinforcement profile, others that will have a reinforcement profile at one of the longitudinal ends, and others that will have a reinforcement profile at each one of the longitudinal ends. If there are two reinforcement profiles, one at each longitudinal end, there is a possibility that each one of the two first faces 7a will have an access opening 70, or that only one of the two reinforcement profiles will have a first face 7a equipped with an access opening 70.

Returning to the manufacture procedure for the door leaf 1, specifically in the sealing phase prior to the injection of the polyurethane foam, it is understood that if the door leaf 1 comprises a single reinforcement profile that has a first face 7a equipped with an access opening 70, this access opening 70 is not entirely covered, so that it can be used to insert an injection nozzle into the space between the two panels 2 and 3. If the door leaf 1 has two reinforcement profiles and they both have respective access openings 70, one of them must be completely covered with an adequate tool so that the polyurethane foam injected through the other access opening 70 does not escape.

Preferably, the mixture will be injected at a pressure between 0.37 and 0.82 Kg/cm², and at a temperature between 27 and 54° C.

The result obtained in said procedure is a door leaf 1 like the one in FIG. 1, wherein the expandable and hardenable foam 6 (polyurethane foam) is visible looking at the top longitudinal edge and the bottom longitudinal edge. If the door leaf 1 is one of those that comprises one or two C-shaped reinforcement profiles, the first face 7a of the profile or each profile will not allow all of the polyurethane foam filling between the front and rear panels 2 and 3 to be visible, but said filling will be seen through the access opening 70, as in the case of the door leaf 1 in FIG. 2. The polyurethane foam filling, when injected, reinforces and secures the hemmed or seamed joints of the longitudinal edges 23-33 and 24-34. This attachment effect, in comparison with the joints of the door leaf before injection (see phase a2 of FIG. 13), ensures better response to fire of the door leaf 1 in case of fire. In addition to this improvement, the polyurethane foam filling provides better thermal and acoustic insulation.

As an example of the finished door leaf 1, preferably, the front panel 2 and rear panel 3 will be made of galvanized or stainless steel sheet metal, stripped sheet metal, pre-painted sheet metal, or plastic-coated sheet metal, with a thickness between 0.5 and 2 mm. Also preferably, the thickness measured from the surface of the front face 20 to the surface of the rear face 30 of the panel is between 10 and 60 mm; and the length of the door leaf 1, measured from the top transversal edge 21 to the bottom transversal edge 22 of the front panel 2 is between 1000 and 6000 mm. Also preferably, the distance between the surfaces of the two lateral edges 40 and 50 of the door leaf 1 is between 150 and 1000 mm.

1. An elevator door leaf formed by a front panel and a rear panel separated from each other but fitted into each other at their longitudinal edges by hemming or seaming, determining a space between the front panel and rear panel that is occupied by an expandable and hardenable foam that is injected under pressure into said space, such that it facilitates the attachment between at least two of the aforementioned paired longitudinal edges created by fitting the front and rear panels together.

2. The elevator door leaf according to claim 1, wherein the hemmed or seamed joints between the front panel and rear panel created by the overlapping of their respective longitudinal edges are formed by two sections of the ends of the longitudinal edges of the front panel folded back onto themselves, with a folded end section of the respective end of the longitudinal edge of the rear panel inserted into the fold.

3. The elevator door leaf according to claim 2, wherein the hemmed or seamed joints between the front panel and the rear panel created by the overlapping of their longitudinal edges are directed in a direction parallel to that of the door leaf essentially aligned with the front face that makes up most of the front panel.

4. The elevator door leaf according to claim 3, wherein on the side of the hemmed or seamed joint that is aligned with the front face of the door leaf, the respective longitudinal edge of the rear panel is folded in an L-shape, with one of the arms of the L-shaped bend forming a first lateral side of the door leaf and the other arm forming the folded end section that is inserted into the section of the front panel that is folded back onto itself to form the hemmed or seamed joint.

5. The elevator door leaf according to claim 3, wherein the other hemmed or seamed joint between the front panel and the rear panel created by the overlapping of their longitudinal edges is directed in a direction perpendicular to that of the door leaf.

6. The elevator door leaf according to claim 5, which comprises, on the side of the hemmed or seamed joint that is directed in a direction perpendicular to that of the door leaf, a second lateral side made up by a folded part of the corresponding longitudinal edge of the front panel, ending at the end thereof that constitutes the section folded over onto itself that creates the hemmed or seamed joint, with an end section of the rear panel that forms a right angle with respect to the rear face of the sheet inserted into the fold of this section folded back onto itself, with the fold extending at a right angle in the opposite direction of the front face.

7. The elevator door leaf according to claim 6, wherein the folded part of the longitudinal edge of the front panel that makes up the second lateral side having a fold at a right angle of the part of the front panel that forms the front face, and the section folded back onto itself of the longitudinal edge is an extension in the same direction of this right-angle fold.

8. The elevator door leaf according to claim 6, wherein the folded part of the longitudinal edge of the front panel that makes up the second lateral side having a first fold at a right angle of the part of the front panel that forms the front face, with the first right-angle fold extending a certain distance beyond the rear face, followed by an offset in the direction parallel to the plane of the rear face and of a second right-angle fold of which the section folded back onto itself of the longitudinal edge forms part.

9. The elevator door leaf according to claim 3, wherein the two hemmed or seamed joints between the front panel and rear panel created by the overlapping of their longitudinal edges, formed by respective sections of the ends of the longitudinal edges of the front panel folded back onto themselves, with a corresponding folded end section of the respective end of the longitudinal edge of the rear panel inserted into said fold, are directed in a direction parallel to the front face that forms most of the front panel and the rear face, which forms most of the rear panel.

10. The elevator door leaf according to claim 1, which comprises, in the space between the front panel and the rear panel, a C-shaped reinforcement profile, that extends side to side between two lateral edges of the door leaf and is arranged at one corresponding longitudinal end of the door leaf, wherein the reinforcement profile is made up of a first flat face and flat second and third faces that are connected perpendicular to the first face, wherein the first face is oriented according to a plane perpendicular to the front face of the panel that makes up most of the front panel, with the first face attached to the respective transversal edges of one longitudinal end of the front face and rear face of the lateral sides of the door leaf, and the first face comprising an access opening connected to the inside space separating the front panel and rear panel, and wherein the second face and the third face of the reinforcement profile extend from the first face in a direction parallel to the front face and the rear face of the door leaf, respectively.

11. The elevator door leaf according to claim 10, which comprises a second C-shaped reinforcement profile at the other longitudinal end of the door leaf, with the second reinforcement profile identical to the reinforcement profile, or with the only difference being that the first face of the second profile does not have the access opening.

12. An elevator door leaf according to claim 1, which comprises, at one of its longitudinal ends, a reinforcement plate in the space between the front panel and the rear panel, arranged parallel and in contact with the inside of the rear panel with the other side forming the rear face of the leaf, with the reinforcement plate extending from side to side between the two lateral edges of the door leaf, and the reinforcement plate being equipped with multiple openings that line up with a series of mounting openings made in the rear face of the leaf that are suitable for installing elements for fastening the elevator door leaf to the elements of the mechanisms that produce the opening and closing movements of the door leaf.

13. The elevator door leaf according to claim 1, wherein the front panel and rear panel are made of galvanized or stainless steel sheet metal, stripped sheet metal, pre-painted sheet metal, or plastic-coated sheet metal, with a thickness between 0.5 and 2 mm.

14. The elevator door leaf according to claim 1, wherein the thickness measured from the surface of the front face to the surface of the rear face of the leaf is between 10 and 60 mm.

15. The elevator door leaf according to claim 1, wherein the length of the door leaf, measured from the top transversal edge to the bottom transversal edge of the front panel is between 1000 and 6000 mm.

16. The elevator door leaf according to claim 1, wherein the distance between the surfaces of the two lateral edges of the door leaf is between 150 and 1000 mm.

17. The elevator door leaf according to claim 6, wherein the perpendicular distance measured from the surface of the front face of the door leaf to the end of the section of the longitudinal edge of the front panel that is folded back on itself that forms the hemmed or seamed joint that is directed in a direction perpendicular to the door leaf, is comprised between 10 and 100 mm.

18. The elevator door leaf according to claim 1, wherein the filling of expandable and hardenable foam injected under pressure that occupies the space between the front panel and the rear panel is an expanded, cured injected polyurethane based on a mixture of at least one polyol with an isocyanate component under reaction conditions.

19. The elevator door leaf according to claim 18 wherein the mixture of at least one polyol component with an isocyanate component, further comprises a blowing agent.

20. A procedure for the manufacture of an elevator door leaf that comprises the forming of a housing with a front panel and a rear panel fitted together by hemming or seaming the longitudinal edges of the front panel with the longitudinal edges of the rear panel, forming a space between the front panel and rear panel, characterized in that an expandable and hardenable foam is injected under pressure into the space between the two panels and is confined under pressure against the front panel and rear panel when it hardens, completely filling the space between the panels.

21. The procedure according to claim 20 wherein the expandable and hardenable foam is an injected polyurethane foam based on a mixture of at least one polyol component and one isocyanate component under reaction conditions.

22. The procedure according to claim 20 in which the expandable and hardenable foam is injected at a pressure between 0.37 and 0.82 Kg/cm², and at a temperature comprised between 27 and 54° C.
